(19) United States
(12) Patent Application Publication
(10) Pub. No.: US 2016/0043973 A1
(43) Pub. Date: Feb. 11, 2016

(54) DYNAMIC RESOLUTION OF MESSAGE CONTENT

(71) Applicant: SF Incubator LLC, Palo Alto, CA (US)

(72) Inventors: Sylvio Drouin, San Francisco, CA (US); Ian Samuel Cinnamon, San Francisco, CA (US)

(21) Appl. No.: 14/709,194

(22) Filed: May 11, 2015

Related U.S. Application Data
(60) Provisional application No. 62/035,576, filed on Aug. 11, 2014.

(51) Int. Cl. H04L 12/58; H04L 29/08

(52) U.S. Cl. CPC H04L 51/046; H04L 67/10

(57) ABSTRACT

Example methods, systems and computer readable media are directed to one or more functionalities that dynamically resolve one or more messages. A functionality identifies content in the message that is required for one or more operations performed by the functionality. By performing such operations, the functionality creates modified message data based on the identified content. An identifier for the modified message data is embedded in the message. The modified message data is stored in relation to an object on a server. By using the embedded identifier, the modified message data can be retrieved by a client application associated with a message recipient. The modified message data can be applied to a received message to update the message.

### CROSS-REFERENCE TO RELATED APPLICATIONS

This application claims the benefit of priority to U.S. Provisional patent application entitled “Smartmail,” Ser. No. 62/035,576, filed Aug. 11, 2014, which is hereby incorporated herein by reference in its entirety.

### TECHNICAL FIELD

The subject matter disclosed herein generally relates to the processing of data. Specifically, the present disclosure addresses systems and methods to facilitate the use of various functionalities to dynamically resolve messages.

### BACKGROUND

Modern conventional messaging systems allow for participants to create and send messages to each other. Participants in a message thread may reply to a specific received message and attach documents to such messages. Other examples of attachments include text documents, images and video. Participants can assign tags to various messages in order to better sort and filter messages. A tag allows all messages assigned to the tag to be grouped together even though the messages may not be part of the same message thread. Conventional messaging systems also come with additional features to keep track of tasks, contact information, and scheduled appointments.

### BRIEF DESCRIPTION OF THE DRAWINGS

Some embodiments are illustrated by way of example and not limitation in the figures of the accompanying drawings.

FIG. 1 is a network diagram illustrating a network environment 100 suitable for dynamically resolving one or more messages, according to some example embodiments.

FIG. 2 is a block diagram illustrating components of a server machine suitable for dynamic resolution of message content, according to some example embodiments.

FIG. 3 is a block diagram illustrating components of a client device suitable for dynamic resolution of message content, according to some example embodiments.

FIG. 4 is a block diagram illustrating a Smartmail messaging environment suitable for dynamic resolution of message content, according to some example embodiments.

FIG. 5 is a flowchart illustrating operations of a client device of a message sender registered in the Smartmail messaging environment performing a method of applying a functionality while a message is being created, according to some example embodiments.

FIG. 6 is a flowchart illustrating operations of a client device of a message recipient registered in the Smartmail messaging environment performing a method of applying a functionality with respect to retrieved modified message data, according to some example embodiments.

FIG. 7 is a flowchart illustrating operations of a client device of a message recipient that is not registered in the Smartmail messaging environment performing a method of applying a functionality with respect to retrieved modified message data according to some example embodiments.

FIG. 8 is a flowchart illustrating operations of a client device of a message sender registered in the Smartmail messaging environment performing a method of applying a functionality to message content, according to some example embodiments.

FIG. 9 is a flowchart illustrating operations of a client device of a message recipient registered in the Smartmail messaging environment performing a method of applying a functionality to message content based on retrieved modified message data, according to some example embodiments.

FIG. 10 is a block diagram illustrating components of a machine, according to some example embodiments, able to read instructions from a machine-readable medium and perform any one or more of the methodologies discussed herein.

### DETAILED DESCRIPTION

Example methods, systems and computer readable media are directed to one or more functionalities that dynamically resolve one or more messages. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A messaging environment (hereinafter “Smartmail messaging environment”) as described herein includes one or more client devices and one or more servers. The client devices and servers perform operations that allow for a functionality to be associated with one or more messages sent amongst various message participants. Each functionality may perform operations with respect to message content as a message is created by a message sender, before the message is sent by the message sender, before the message is accessed by a message recipient and as the message recipient generates a reply to the message.

A functionality identifies content in the message that is required for one or more operations performed by the functionality. The functionality dynamically performs operations based on the identified content. By performing such operations, a functionality creates modified message data based on the identified content. A functionality may also perform operations with respect to modified message data generated by other functionalities. An identifier for the modified message data is embedded in the message. The functionality creates an object and the modified message data is stored in relation to the object on a Smartmail server in the Smartmail messaging environment.

By using the embedded identifier, the modified message data can be retrieved from the Smartmail server by a Smartmail client application associated with a message recipient. The modified message data can be applied to a received message to update the message. By updating the message according to retrieved modified message data, the nature and scope of the communication between the message sender and message recipient can be enhanced or resolved without having required any further input from the message sender and the message recipient. It is understood that various embodiments of Smartmail messaging environment can be directed to handling and processing any type of message.

It is further understood that, in various embodiments, any of the actions and/or operations described herein can be performed by one or more modules that comprise source code. Such modules may be sent to a computing device. When compiled by the computing device, object code is generated that causes the computing device to perform various the actions and/or operations described herein. In other embodiments, such modules comprise object code that causes the computing device(s) to perform various actions described herein.

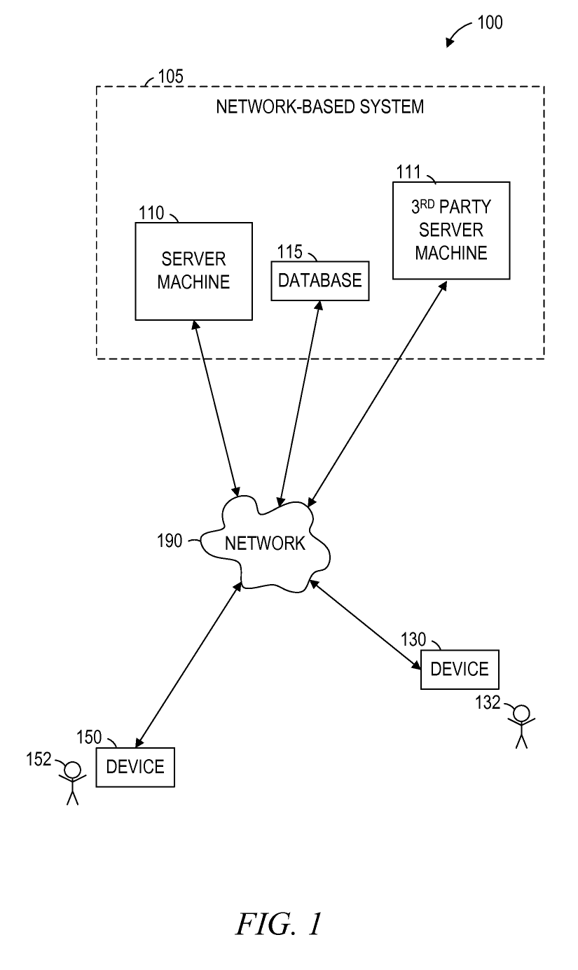

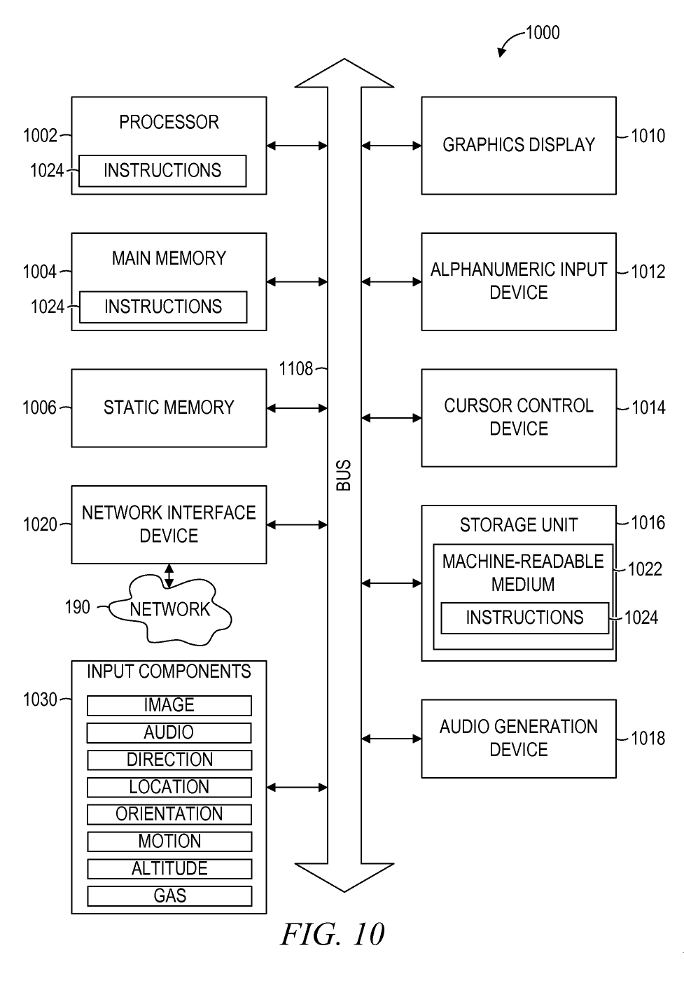

FIG. 1 is a network diagram illustrating a network environment 100 suitable for dynamically resolving one or more messages, according to some example embodiments. The network environment 100 includes a server machine 110, a database 115, a 3^{rd} Party server machine 111 and devices 130 and 150, all communicatively coupled to each other via a network 190. The server machines 110, 111 may form all or part of a network-based system 105 (e.g., a cloud-based server system configured to provide one or more services to the devices 130 and 150). The server machines 110, 111 and the devices 130 and 150 may each be implemented in a computer system, in whole or in part, as described below with respect to FIG. 10.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machines 110, 111 and the devices 130, 150). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

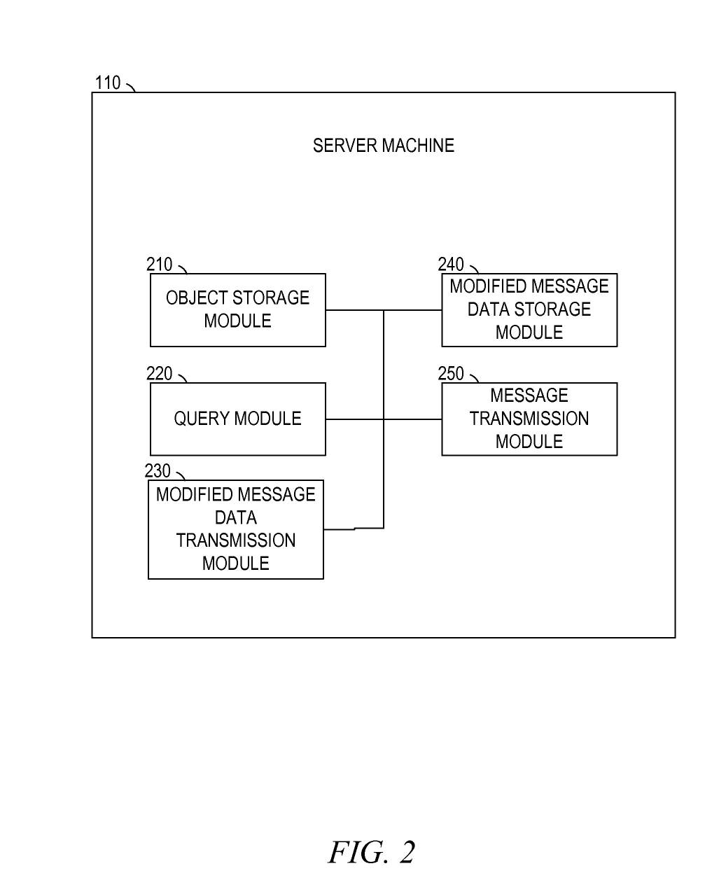

FIG. 2 is a block diagram illustrating components of a server machine suitable for dynamic resolution of message content, according to some example embodiments. The server machine 110 is shown as including an object storage module 210, a query module 220, a modified message data transmission module 230, a modified message data storage module 240 and a message transmission module 250.

The modules 210-250 are configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The user object storage module 210 may be a hardware-implemented module which manages, controls, stores, and accesses information associated with receiving objects created by one or more functionalities and storing the objects in relation to modified message data and additional information such session identifiers, message participant identifiers, and plug-in identifiers for plug-ins involved in generating the modified message data.

The query module 220 may be a hardware-implemented module which manages, controls, stores, and accesses information associated with determining whether one or more message recipients are registered in the Smartmail messaging environment. A message recipient is registered in the Smartmail messaging environment based on having installed a Smartmail client application on a client device.

The modified message data transmission module 230 may be a hardware-implemented module which manages, controls, stores, and accesses information associated with receiving requests from modified message data and sending modified message data to one or more client devices.

The modified message data storage module 240 may be a hardware-implemented module which manages, controls, stores, and accesses information associated with storing modified message data in relation to one or more objects.

The message transmission module 250 may be a hardware-implemented module which manages, controls, stores, and accesses information associated with sending messages amongst message participants that are registered in the Smartmail messaging environment.

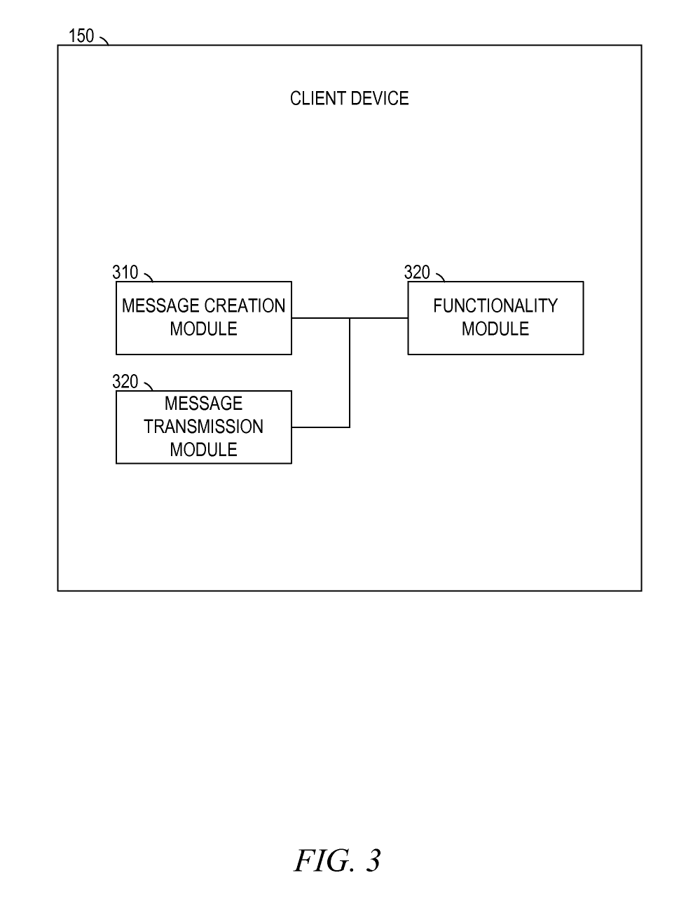

FIG. 3 is a block diagram illustrating components of a client device suitable for dynamic resolution of message content, according to some example embodiments. The client device 150 is shown as including a message creation module 310, a message transmission module 320 and a functionality module 330. It is understood that multiple client device may include modules 310-330.

The modules 310-330 are configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The message creation module 310 may be a hardware-implemented module which manages, controls, stores, and accesses information associated with creation, storage, receipt and display of one or more messages. The message creation module 310 may be associated with a Smartmail client application

The functionality module 320 may be a hardware-implemented module which manages, controls, stores, and accesses information associated with executing a functionality with respect to one or more messages and one more message threads. The functionality module 320 further manages, controls, stores, and accesses information associated with creation of objects and modified message data for storage in relation to each other at a server. The functionality module 320 may be associated with one or more functionalities for execution within a Smartmail client application.

The message transmission module 330 may be a hardware-implemented module which manages, controls, stores, and accesses information associated with sending a message to a Smartmail server 110 and a 3^{rd} Party Messaging Service server 111. The message transmission module 330 may be associated with a Smartmail client application.

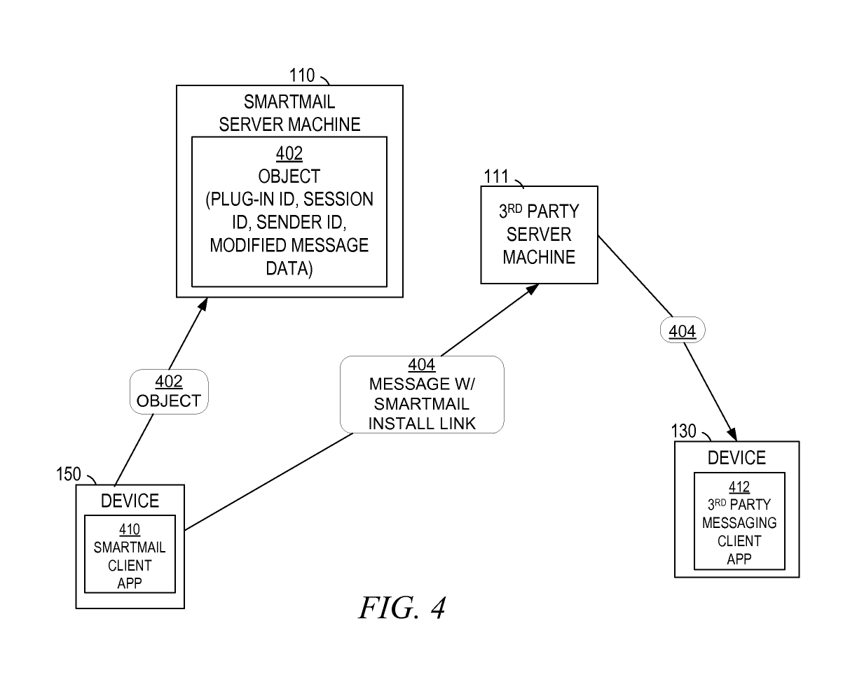

FIG. 4 is a block diagram illustrating a Smartmail messaging environment suitable for dynamic resolution of message content, according to some example embodiments. The Smartmail messaging environment includes a client device 150 that has already installed a Smartmail client application 410 and a Smartmail server machine 110.

A message sender generating a message 404 at client device 150 is a registered user in the Smartmail messaging environment. A functionality (hereinafter “plug-in”) selected by the message sender has applied one or more operations to message content to create modified message data. The plug-in executes within the Smartmail client application 410 with respect to content from one or more messages. The plug-in creates an object 402 to be stored on the Smartmail server 110. The plug-in also creates an identifier for the object 402 and embeds the identifier in a header of the message 404. The plug-in sends the object 402 to the Smartmail server 110. The object 402 is stored on the Smartmail server in relation to a plug-in identifier, a session identifier, a message sender identifier and the modified message data.

The Smartmail client application 410 associated with the message sender sends a query to the Smartmail server 110 (or database 115) to determine whether the message recipient associated with client device 130 is registered in the Smartmail messaging environment. If the message recipient is not registered, the Smartmail client application 410 on the message sender's client device 150 inserts a link into the body of the message 404. The link is for installation of the Smartmail client application at the client device 130 of the message recipient. The Smartmail client application 410 associated with the message sender sends the message 404 (with the installation link) to the message recipient via a 3^{rd} Party messaging service server 111, while the modified message data remains stored on the Smartmail server in relation to the object 402. Once the message recipient accesses the received message 404 and installs the Smartmail client application on the client device 130, the newly-installed Smartmail client application may retrieve the modified message data from the Smartmail server to update the message 404 prior to access of the message 404 by the message sender.

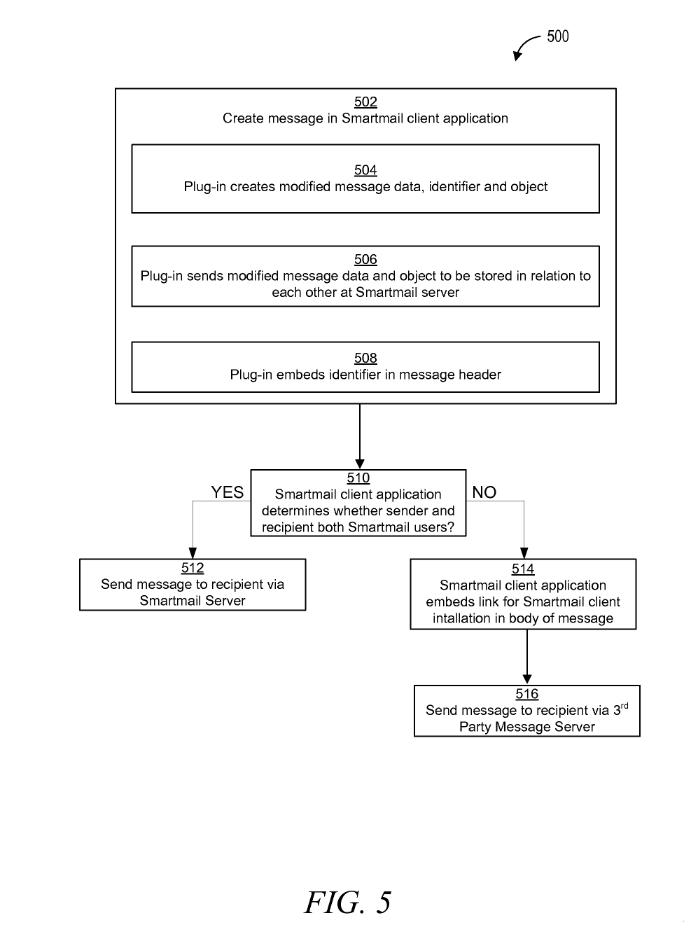

FIG. 5 is a flowchart illustrating operations of a client device of a message sender registered in the Smartmail messaging environment performing a method 500 of applying a functionality while a message is being created, according to some example embodiments.

A Smartmail client application for the Smartmail messaging environment is installed in the client device and a user of the client device is registered in the Smartmail messaging environment. At operation 502, the user (hereinafter “message sender”) of the client device creates a message in the Smartmail client application. The Smartmail client application running on the client device receives a selection by the message sender of a functionality (hereinafter “plug-in”) to be associated with the message.

The plug-in executes within the Smartmail client application with respect to the message as the message is being created. It is understood that multiple plug-ins can be associated with the message and may act on message content independently or in combination with each other. In some embodiments, a plug-in can be selected to be associated with one more messages. A plug-in can also be selected to be associated with one or more message threads.

At operation 504, as the message sender creates the message in the Smartmail client application, the plug-in identifies content in a portion of the message that is required by the plug-in. The plug-in creates modified message data based on the identified content and an identifier for the modified message data. The plug-in creates an object to be stored on a Smartmail server in the Smartmail messaging environment. The object may be identified according to the identifier.

At operation 506, the plug-in sends the object and the modified message data to the Smartmail server. The modified message data is stored at the Smartmail server in relation to the object that is identified by the identifier.

At operation 508, the plug-in embeds the identifier in a header of the message. The message sender completes creation of the message and sends the message to an intended message recipient(s). In some embodiments, the plug-in may update the message according to the modified message data while the message sender drafts the message. In other embodiments, the plug-in may update the message according to the modified message data after the message sender completes drafting the message but before the message is sent to the intended message recipient.

At operation 510, the Smartmail client application may query a Smartmail server that is part of the Smartmail messaging environment in order to determine whether the message sender and the intended message recipient are both registered in the Smartmail messaging environment. That is, if both are registered in the Smartmail messaging environment, at operation 512, the Smartmail client application sends the message through the Smartmail server since the intended message recipient is associated with a client device in which the Smartmail client application has also been installed.

However, if the intended message recipient is not registered in the Smartmail messaging environment, at operation 514, the Smartmail client application embeds a link in the message. The link is an address from which the intended message recipient can install the Smartmail client application on their respective client device.

At operation 516, the Smartmail client application sends the message with the embedded installation link to a 3^{rd} party messaging server. The intended message recipient will thereby receive the message with the embedded installation link via the 3^{rd} party messaging service, while the modified message data will still reside on the Smartmail server.

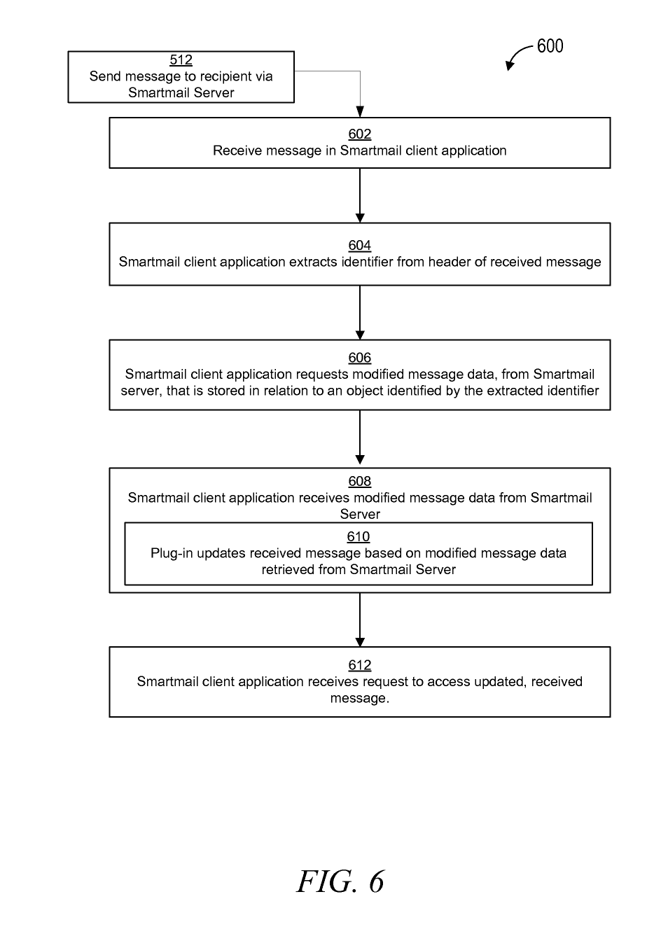

FIG. 6 is a flowchart illustrating operations of a client device of a message recipient registered in the Smartmail messaging environment performing a method 600 of applying a functionality with respect to retrieved modified message data, according to some example embodiments.

At operation 602, the Smartmail client application installed on a client device associated with the message recipient receives the message from the Smartmail Server since the message recipient is registered in the Smartmail messaging environment.

At operation 604, the Smartmail client application extracts the identifier embedded in the message. Based on the extracted identifier, at operation 406, the Smartmail client application requests the modified message data stored in relation to an object at the Smartmail server.

At operation 608, the Smartmail client application receives the modified message data from the Smartmail server. At operation 610, based on the received modified message data, the plug-in that created the modified message data at the message sender's client device is activated in the Smartmail client application. If the plug-in that created the modified message data is not currently installed on the message recipient's client device, the plug-in may be automatically acquired and installed on the client device.

The plug-in updates the received message according to the modified message data received from the Smartmail server. In one embodiment, the plug-in generates new modified message data based on the retrieved modified message data and updates the received message data with the new modified message data. In some embodiments, the plug-in updates the received message before the received message is accessed by the message recipient. In other embodiments, the plug-in updates the received message as the message recipient views the received message.

At operation 612, the Smartmail client application receives a request from the message recipient to access the received message that has been updated by the plug-in according to the modified message data. In response to the request, the Smartmail client application presents a view of an updated version of the received message.

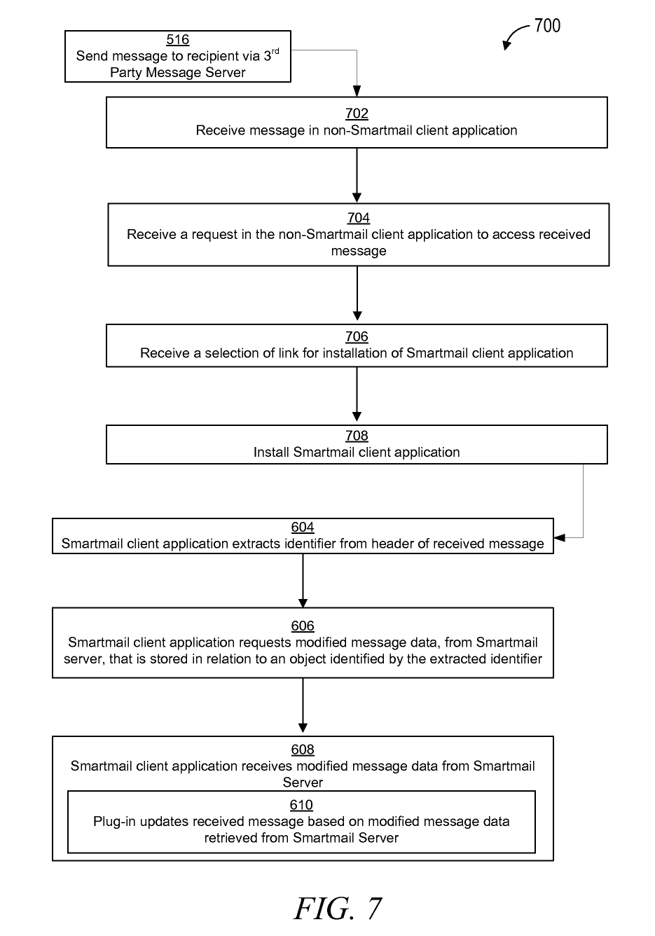

FIG. 7 is a flowchart illustrating operations of a client device of a message recipient that is not registered in the Smartmail messaging environment performing a method 700 of applying a functionality with respect to retrieved modified message data according to some example embodiments.

At operation 702, a 3^{rd} party messaging client application installed on a client device associated with the message recipient receives the message from a 3^{rd} party messaging server. Since, the message recipient is not registered in the Smartmail messaging environment, the received message includes a link to an address from which the message recipient can install the Smartmail client application.

At operation 704, the 3^{rd} party messaging client application receives a request from the message recipient to access the message. At operation 706, the 3^{rd} party messaging client application receives a selection by the message recipient of the link in the message.

At operation 708, in response to selection of the link, the client device receives the Smartmail client application for installation at the client device. The client device installs the Smartmail client application. The received message is accessible via the newly-installed Smartmail client application. Method 700 continues with operations 604-610 as described above in connection with FIG. 6.

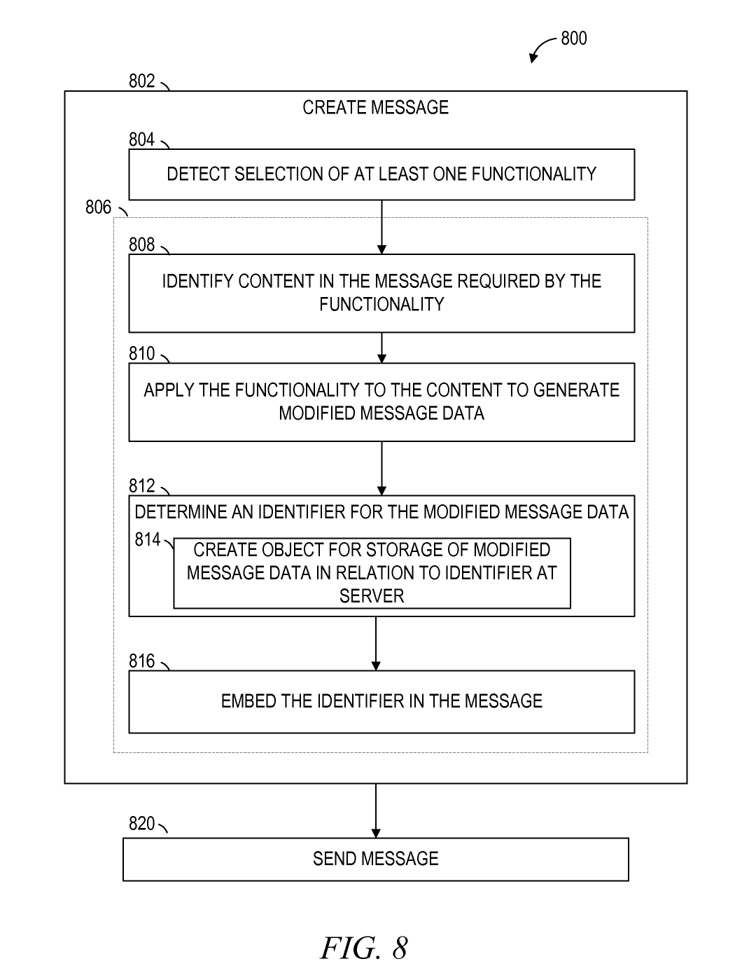

FIG. 8 is a flowchart illustrating operations of a client device of a message sender registered in the Smartmail messaging environment performing a method 800 of applying a functionality to message content, according to some example embodiments.

At operation 802, a message sender creates a message within a Smartmail client application. At operation 804, the Smartmail client application detects selection of a functionality. A functionality may be selected to perform operations on content from one or more messages or one or more message threads.

A functionality may be a scheduling plug-in. In one embodiment, the client device receives the scheduling plug-in from an online store. Upon purchase of the scheduling plug-in from the online store, the scheduling plug-in is received at the client device from the online store. The scheduling plug-in is installed at the client device and instantiated to execute within the Smartmail client application. It is understood that the functionality is not limited to the scheduling plug-in and that the scheduling plug-in is described herein as merely an example of a functionality applied to content in the message.

At operation 806, the functionality performs various operations 808-816 based on content in the message. At operation 808, the functionality identifies content in the message that is required by the functionality. For example, the scheduling plug-in identifies content that is resolvable by the scheduling plug-in. Such resolvable content for the scheduling plug-in may be content that describes an event that requires a date and time that is currently available for both the message sender and the message recipient.

At operation 810, the functionality is applied to the content to generate modified message data. For example, the scheduling plug-in accesses a scheduling application on the client device of the message sender. It is understood that the scheduling application need not be on the client device. In various embodiments, the scheduling plug-in may access the scheduling application via a cloud computing environment. It is further understood that any plug-in applied to message content may access any type of application as well as any type of previously generated modified message data and message content from other messages in order to generate new modified message data.

The scheduling plug-in searches for one or more periods of time in the scheduling application that are available for the event described in the content of the message. The scheduling plug-in identifies one or more available periods of time in the scheduling application for the event. The scheduling plug-in generates modified message data based on the one or more available periods of time for the message sender to attend the event.

In some embodiments, the scheduling plug-in updates the message with the modified message data as the message sender composes the message. Therefore, as the message sender composes the message, the scheduling plug-in inserts text describing one more available periods of time for the event.

At operation 812, the functionality determines an identifier for the modified message data. At operation 814, the functionality further creates an object for storage of the modified message data in relation to the identifier at a Smartmail server. For example, the scheduling plug-in creates an identifier for the modified message data. The scheduling plug-in creates an object for storage of the modified message data at the Smartmail server.

In some embodiments, additional modified message data created from content related to the message may be stored in related to the object. For example, any plug-in(s) selected by a message recipient to reply to the message will generate additional modified message data that may be further stored at the Smartmail server in relation to the object.

Additional recipients of the message may be added during the lifecycle of the message thread. In some embodiments, any plug-in(s) selected by an additional recipient to reply to the message will generate modified message data that may also be further stored at the Smartmail server in relation to the object. In other embodiments, any plug-in(s) selected by an additional recipient to reply to the message will generate new modified message data and a new object so that the new modified message data will be stored at the Smartmail server in relation to the new object.

The object may thereby be stored on the Smartmail server in relation to modified message data generated by multiple plug-ins applied to content from various replies that occur during one or more message threads. In some embodiments, a plug-in accesses the modified message data created by a different plug-in(s) stored on the Smartmail server in order to further generate new modified message data based on message content and the accessed modified message data. In other embodiments, a search functionality can be executed on the modified message data stored on the Smartmail server.

At operation 816, the functionality embeds the identifier in the message. The identifier identifies the object on the Smartmail server.

At operation 820, Smartmail client application sends the message. In some embodiments, the functionality may update the message with the modified message data before it is sent.

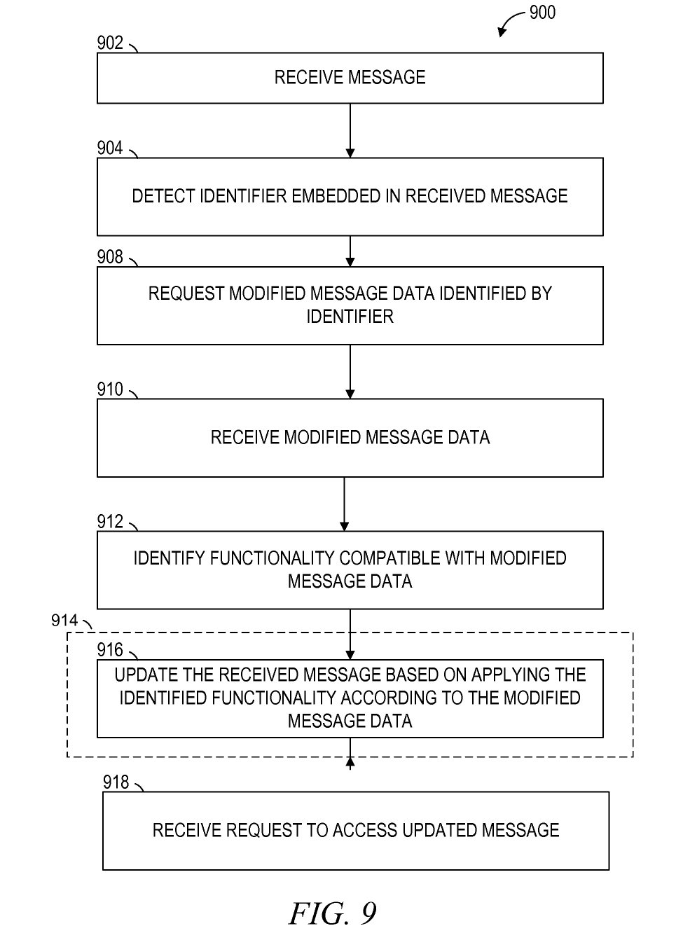

FIG. 9 is a flowchart illustrating operations of a client device of a message recipient registered in the Smartmail messaging environment performing a method 900 of applying a functionality to message content based on retrieved modified message data, according to some example embodiments.

At operation 902, a Smartmail client application running on a client device receives a message. The Smartmail client application is associated with a message recipient registered in the Smartmail messaging environment.

At operation 904, the Smartmail client application detects an identifier embedded in the received message. The Smartmail client application extracts the identifier.

At operation 908, the Smartmail client application sends a request to a Smartmail server in the Smartmail messaging environment for modified message data. The request for the modified message data includes the identifier. The requested modified message data is stored on the Smartmail server in relation to an object that is identified by the extracted identifier.

At operation 910, the Smartmail client application receives the modified message data from the Smartmail server. At operation 912, the Smartmail client application identifies one or more functionalities compatible with the modified message data received from the Smartmail server. For example, the modified message data may be modified message data created by the scheduling plug-in described above in connection with FIG. 8.

Based on identifying the compatible functionality, the compatible functionality is instantiated in the Smartmail client application. Operation 914 of FIG. 9 illustrates steps performed by the compatible functionality. At operation 916, the compatible functionality updates the received message according to the received modified message data.

For example, continuing with the example of the scheduling plug-in described in connection with FIG. 8, the Smartmail client application has instantiated the scheduling plug-in based on the received modified message data. The scheduling plug-in accesses a scheduling application on the client device in order to identify one or more available periods of time for the event described in the received message.

The scheduling plug-in reconciles the one or more available periods of times in the received modified message data with one or more available periods of time in the scheduling application associated with the message recipient. The scheduling plug-in identifies a period time for the event during which both the message sender and the message recipient are available. The scheduling plug-in generates additional modified message data based on the identified period time for the event during which both the message sender and the message recipient are available.

The scheduling plug-in sends the additional modified message data to the Smartmail to be stored in relation to the object. The scheduling plug-in further updates the received message with the additional modified message data prior to access of the received message by the message recipient. When the message recipient accesses the received message, the received message has already been updated by the scheduling plug-in such that it includes message content describing the identified period time for the event during which both the message sender and the message recipient are available.

In this example, the received message now includes content describing a proposed date and time for an event even though neither the message sender nor the message recipient provided input regarding which date and time is preferred. Instead, the scheduling plug-ins running on the respective client devices of the message sender and the message recipient accessed scheduling application data and dynamically resolved the issue of scheduling the event on behalf of the message sender and the message recipient.

At operation 918, the Smartmail client application receives a request from the message recipient to access the received message, which has previously been updated by the scheduling plug-in to include content describing the identified period time for the event during which both the message sender and the message recipient are available.

According to various example embodiments, one or more of the methodologies described herein to dynamically resolve message content as described above. When these effects are considered in aggregate, one or more of the methodologies described herein may obviate a need for certain efforts or resources that otherwise would be involved in resolving message content as described above. Efforts expended by a user in resolving message content may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 10 is a block diagram illustrating components of a machine 1000, according to some example embodiments, able to read instructions 1024 from a machine-readable medium 1022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 may contain microcircuits that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the processor 1002 (e.g., within the processor's cache memory), or both, before or during execution thereof by the machine 1000. Accordingly, the main memory 1004 and the processor 1002 may be considered machine-readable media (e.g., tangible and non-transitory machine-readable media). The instructions 1024 may be transmitted or received over the network 190 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device, such as a smart phone or tablet computer, and have one or more additional input components 1030 (e.g., sensors or gauges). Examples of such input components 1030 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A computer-implemented method, comprising:
identifying content in at least a portion of the message, the content comprising content required by a first functionality;
applying the first functionality to the content to generate modified message data;
determining an identifier for the modified message data; and
embedding the identifier in the message.

2. The computer-implemented method of claim 1, wherein applying the first functionality to the content to generate modified message data comprises:
applying the first functionality prior to completion of the message.

3. The computer-implemented method of claim 1, wherein identifying content in at least a portion of the message comprises:
detecting content resolvable by the first functionality; and
based on detecting the content, applying the first functionality to the detected content to generate the modified message data.

4. The computer-implemented method of claim 3, wherein applying the first functionality to the detected content to generate modified message data comprises:
identifying application data created by an application having an application functionality that corresponds to the first functionality; and
generating the modified message data based at least on a result of resolving the detected content against the application data.

5. The computer-implemented method of claim 4, further comprising:
wherein the first functionality comprises a scheduling functionality;
wherein the detected content describes an event;
wherein the application comprises a scheduling application;
wherein the application data comprises at least one period of time in the scheduling application and a respective status of the at least one period of time in the scheduling application; and
wherein the modified message data comprises at least one period of time for the event in the scheduling application.

6. The computer-implemented method of claim 1, wherein identifying content in at least a portion of the message comprises:
detecting the content as the content is created in the at least a portion of the message.

7. The computer-implemented method of claim 1, wherein applying the first functionality to the content to generate modified message data comprises:
encrypting the content according to an encryption functionality; and
generating decryption message data via the encryption functionality, the decryption message data for decrypting the content.

8. The computer-implemented method of claim 1, further comprising:
creating an object for storage at a server computing device;
sending the object to the server computing device; and
sending the modified message data for storage in relation to the object at the server computing device.

9. The computer-implemented method of claim 1, further comprising:
generating a view based on a version of the message, wherein the version of the message comprises the content updated according to the modified message data.

10. The computer-implemented method of claim 9, further comprising:
generating the view based on the version of the message prior to completion of the message.

11. The computer-implemented method of claim 1, further comprising at least one of:
communicating, by the first functionality, with a second functionality executed in a client application in which the content is created;
communicating, by the first functionality, with the client application; and
communicating, by the first functionality, with at least one service external to the client application.

12. A computer-implemented method comprising:
generating, at a first computing device, at least one module to cause a second computing device to:
identify content in at least a portion of the message, the content comprising content required by a first functionality;
apply the first functionality to the content to generate modified message data.
determine an identifier for the modified message data; and
embed the identifier in the message; and
sending, from the first computing device, the at least one module to a module repository.

13. A computer-implemented method comprising:
detecting an identifier embedded in a received message;
initiating a request for first modified message data identified by the identifier;
receiving the first modified message data;
identifying a functionality compatible with the first modified message data; and
updating at least a portion of the received message based on applying the identified functionality according to at least the first modified message data.

14. The computer-implemented method of claim 13, wherein updating at least a portion of the received message based on applying the identified functionality according to at least the first modified message data comprises:
updating the at least a portion of the received message prior to access of the received message.

15. The computer-implemented method of claim 13, wherein updating at least a portion of the received message based on applying the identified functionality according to at least the first modified message data comprises:
updating the at least a portion of the received message with second modified message data generated via the identified functionality.

16. The computer-implemented method of claim 15, comprising:
initiating transmission of the second modified message data for storage in relation to an object stored at a server computing device, the object referenced by the identifier.

17. The computer-implemented method of claim 15, wherein updating the at least a portion of the received message with second modified message data comprises:
identifying application data created by an application having an application functionality that corresponds to the identified functionality; and
generating the second modified message data based at least on a result of resolving the first modified message data against the application data.

18. The computer-implemented method of claim 17, comprising:
wherein the identified functionality comprises a scheduling functionality;
wherein the application comprises a first scheduling application;
wherein the application data comprises at least one period of time in the first scheduling application and a respective status of the at least one period of time in the first scheduling application;
wherein the first modified message data comprises at least one period of time for an event in a second scheduling application; and
wherein the second modified message data comprises at least one period of time for the event in the first and second scheduling applications.

19. The computer-implemented method of claim 15, wherein updating the at least a portion of the received message with second modified message data comprises:
replacing the at least a portion of the received message with the second modified message data prior to access of the received message.

20. The computer-implemented method of claim 19, wherein receiving the first modified message data comprises:
receiving decryption message data.

21. The computer-implemented method of claim 20, wherein identifying a functionality compatible with the first modified message data comprises:
identifying a decryption functionality compatible with the decryption message data.

22. The computer-implemented method of claim 21, wherein applying the identified functionality according to at least the first modified message data comprises:
applying the decryption functionality, according to the decryption message data, to the at least a portion of the received message to generate the second modified message data, wherein the second modified message data comprises a decrypted version of the at least a portion of the received message.

23. The computer-implemented method of claim 13, wherein initiating a request for first modified message data identified by the identifier comprises:
creating a request based on the identifier, wherein the identifier references an object stored in relation to the first modified message data at a server computing device.

24. A computer-implemented method, comprising:
generating, at a first computing device, at least one module to cause a second computing device to:
update at least a portion of a received message based on applying an identified functionality according to at least first modified message data, the first modified message data identified according to an identifier embedded in the received message; and
sending, from the first computing device, the at least one module to a module repository.
